(19) United States
(12) Patent Application Publication
(10) Pub. No.: US 2013/0063748 A1
(43) Pub. Date: Mar. 14, 2013

(54) IMAGE FORMING APPARATUS AND METHOD FOR SETTING COPY MODE IN IMAGE FORMING APPARATUS

(71) Applicant: Toshifumi Mimura, Kanagawa-ken (JP)

(72) Inventor: Toshifumi Mimura, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/605,016

(22) Filed: Sep. 6, 2012

Related U.S. Application Data
(60) Provisional application No. 61/532,168, filed on Sep. 8, 2011.

(51) Int. Cl. G06F 3/12

(52) U.S. Cl. 358/1.13

(57) ABSTRACT

According to one embodiment, an image forming apparatus includes a scanner, a first image forming section, a second image forming section, a detector, and a setting section. The scanner reads the image of an original document. The first image forming section forms an image on paper with a non-decolorizable recording material. The second image forming section forms an image on paper with a decolorizable recording material. The detector detects whether the original document image is formed with the decolorizable recording material. The setting section sets a copy mode for forming an image of the original document on paper with the second image forming section upon the detector detecting that the original document image is formed with the decolorizable recording material.

### CROSS-REFERENCE TO RELATED APPLICATIONS

This application is based upon and claims the benefit of priority from U.S. Provisional Application No. 61/532,168, filed on Sep. 8, 2011; the entire contents of which are incorporated herein by reference.

### FIELD

Embodiments described herein relate generally to an image forming apparatus, and a method for setting a copy mode in an image forming apparatus.

### BACKGROUND

An image forming apparatus that includes a plurality of image forming sections requires setting to choose an image forming section used to form an image of an original document on paper in copying. For example, an image forming apparatus is available that includes a first image forming section used to form an image with a non-decolorizable recording material, and a second image forming section used to form an image with a decolorizable recording material. While such an image forming apparatus of related art is capable of preferentially setting either image forming section, it is not capable of setting to select an image forming section according to the state of the original document image in copying.

### BRIEF DESCRIPTION OF THE DRAWINGS

FIG. 1 is a diagram representing an example of an external configuration of a digital multi-functional peripheral as an image forming apparatus according to an embodiment.

FIG. 2 is a block diagram explaining an example of a configuration of a control system in the digital multi-functional peripheral according to the embodiment.

FIG. 3 is a diagram representing an example of an external configuration of a control panel according to the embodiment.

FIG. 4 is a flow chart explaining an example of a first copying process of the digital multi-functional peripheral according to the embodiment.

FIG. 5 represents an example of a setting screen displayed in a display section of the control panel according to the embodiment.

FIG. 6 represents an example of a setting screen displayed in the display section of the control panel according to the embodiment.

FIG. 7 is a flow chart explaining a second copying process of the digital multi-functional peripheral according to the embodiment.

FIG. 8 represents an example of a copy mode confirmation screen displayed in the display section of the control panel according to the embodiment.

FIG. 9 represents an example of a copy mode confirmation screen displayed in the display section of the control panel according to the embodiment.

FIG. 10 is a flow chart explaining a third copying process of the digital multi-functional peripheral according to the embodiment.

FIG. 11 represents an example of a setting screen displayed in the display section of the control panel according to the embodiment.

### DETAILED DESCRIPTION

In general, according to one embodiment, an image forming apparatus includes a scanner, a first image forming section, a second image forming section, a detector, and a setting section. The scanner reads an original document image. The first image forming section forms an image on paper with a non-decolorizable recording material. The second image forming section forms an image on paper with a decolorizable recording material. The detector detects whether the image on the original document set on the scanner is formed with the decolorizable recording material. The setting section sets a copy mode for forming an image of the original document on paper with the second image forming section upon the detector detecting that the original document image is formed with the decolorizable recording material.

An embodiment is described below in detail with reference to the accompanying drawings.

First, the configuration of a digital multi-functional peripheral (MFP; image forming apparatus) is described.

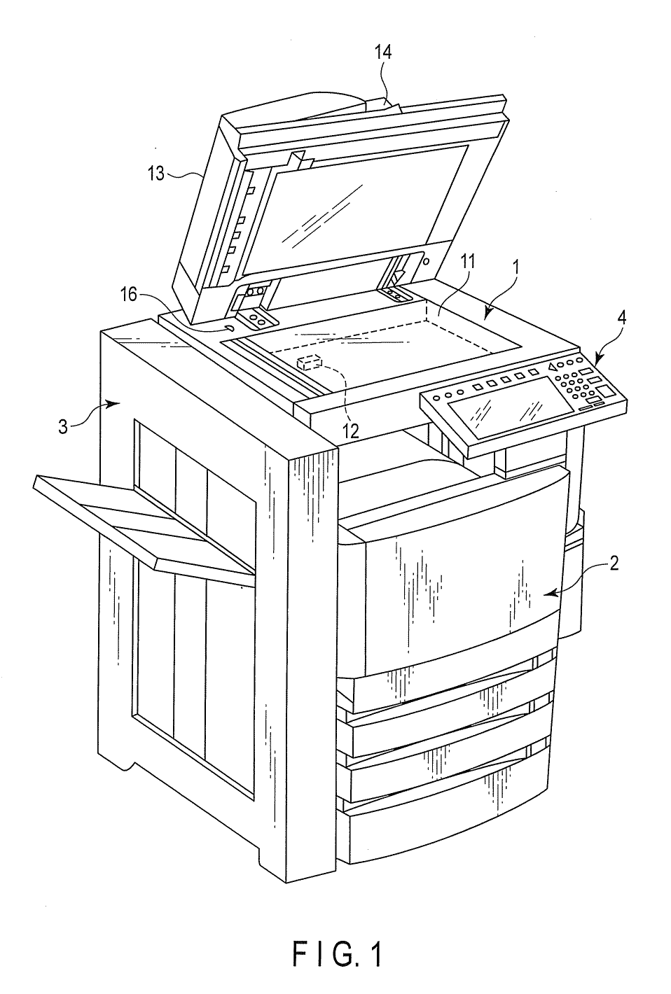

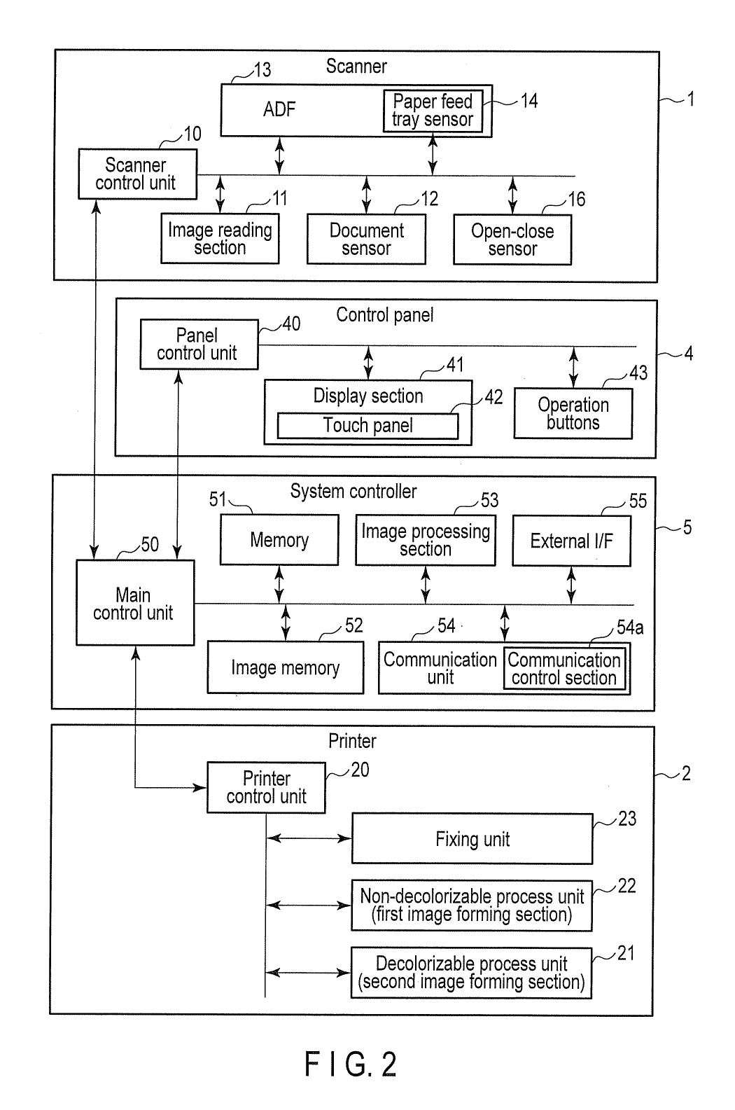

FIG. 1 is a perspective view representing an example of an external configuration of the digital multi-functional peripheral. FIG. 2 is a block diagram explaining an example of a configuration of a control system in the digital multi-functional peripheral.

As illustrated in FIG. 1, the digital multi-functional peripheral includes a scanner 1, a printer 2, a finisher 3, and a control panel 4. Further, as illustrated in FIG. 2, the digital multi-functional peripheral includes a system controller 5 provided for the overall control of the apparatus. The system controller 5 is connected to the scanner 1, the printer 2, and the control panel 4. The system controller 5 controls the scanner 1, the printer 2, and the control panel 4 as a whole.

The scanner 1 is described first.

The scanner 1 is disposed on the upper part of the main body of the digital multi-functional peripheral. The scanner 1 is a reading device that optically reads an original document image. The scanner 1 is controlled by a scanner control unit 10. The scanner control unit 10 outputs to the system controller 5 signals detected by sensors, and controls the scanner 1 according to control signals from the system controller 5.

The scanner 1 includes an image reading section 11 that reads an image formed on the original document set on platen glass G, or an image formed on the original document carried by an ADF 13. The image reading section 11 includes a photoelectric converter realized by, for example, a CCD line sensor that converts an original document image of each line into image data along the main scan direction. The image reading section 11 reads the image of the whole original document by scanning the original document in the vertical scan direction of the original document with the CCD line sensor.

The scanner 1 includes a document sensor 12 that detects the original document set on the platen glass G. The platen glass G serves as a platen for putting an original document scanned by the image reading section 11. The image reading section 11 scans the image of the original document set on the platen glass G with the image side facing the glass. The document sensor 12 outputs a signal indicative of the presence or absence of an original document on the platen glass G. The document sensor 12 may be a sensor that detects the size of the original document on the platen glass G.

The scanner 1 includes the ADF (auto document feeder) 13. The ADF 13 includes a paper feed tray 14 and a paper feed tray sensor 15. The paper feed tray 14 holds original documents to be read. The paper feed tray sensor 15 detects whether an original document is present on the paper feed tray 14. The original documents held on the paper feed tray 14 are carried one by one by the ADF 13. The scanner 1 reads the image of the original document carried by the ADF 13.

In the scanner 1, the ADF 13 also serves as a cover for the original document placed on the platen glass G. The ADF 13 is installed on the platen glass G in the main body of the digital multi-functional peripheral in a manner allowing the whole body of the ADF 13 to open and close. The scanner 1 includes an open-close sensor 16 that detects the open-close state of the ADF 13. For example, the open-close sensor 16 outputs a signal indicative of the opened state when the ADF 13 as an original document cover is opened by a user to set an original document on the platen glass G.

The printer 2 forms an image on a paper used as an image formation target medium. The printer 2 serves to form an image on paper with a non-decolorizable recording material, and to form an image on paper with a decolorizable recording material. For example, as represented in FIG. 2, the printer 2 of the embodiment includes a non-decolorizable process unit (first image forming section) 21, a decolorizable process unit (second image forming section) 22, and a fixing unit 23. The non-decolorizable process unit 21 forms an image on paper with a non-decolorizable recording, material. The decolorizable process unit 22 forms an image on paper with a decolorizable recording material.

As represented in FIG. 2, the printer 2 is controlled by a printer control unit 20. The printer control unit 20 controls the operation of the printer 2 according to a control signal from the system controller 5. For example, according to a control signal from the system controller 5, the printer control unit 20 selects the non-decolorizable process unit 21 or the decolorizable process unit 22 as a process unit for forming an image on paper. The printer control unit 20 also controls the fixing unit 23 according to the selected process unit used to form an image on paper.

In this embodiment, the printer 2 is described as being an electrophotographic printer. For example, in the printer 2 of the embodiment, the non-decolorizable process unit (first image forming section) 21 forms an image on paper with a non-decolorizable toner as a non-decolorizable recording material (for example, a black toner or a color toner). The decolorizable process unit (second image forming section) 22 forms an image on paper with a decolorizable toner as a decolorizable recording material (for example, a monochromatic (e.g., blue) toner).

The fixing unit 23 fixes the image formed (transferred) on paper. It should be noted that the fixing unit 23 may be provided for each of the non-decolorizable process unit 21 and the decolorizable process unit 22, because the non-decolorizable toner and the decolorizable toner may have different fixing temperatures. Further, the fixing unit 23 may be adapted to control the fixing temperature according to image formation by the non-decolorizable process unit 21 and image formation by the decolorizable process unit 22.

As noted above, the printer 2 is described as an electrophotographic printer in this embodiment. However, the printer 2 may be any printer, as long as it can form a non-decolorizable image and a decolorizable image, and may be an inkjet printer or a thermal transfer printer. For example, the printer 2 may be a printer that forms an image by using a liquid ink as the decolorizable recording material, or a printer that forms an image by using a gel ink as the decolorizable recording material.

Further, the decolorizable recording material used in the decolorizable process unit (second image forming section) 22 is not particularly limited, as long as it can be decolored, for example, by heating. For example, a leuco dye may be used as the color for the decolorizable recording material. In this case, the decolorizable recording material is appropriately combined with other materials such as a color developing agent, a decoloring agent, and a discoloration temperature adjuster, so that decolorization occurs at or above a certain temperature.

The following describes a color forming compound such as a leuco dye as an example of the decolorizable recording material, along with a color developing agent and a decoloring agent.

The leuco dye is an electron-donating compound that can develop color with the color developing agent. Examples of the leuco dye include diphenylmethane phthalides, phenylindolyl phthalides, indolyl phthalides, diphenylmethane azaphthalides, phenylindolyl azaphthalides, fluorans, styrylquinolines, and diazarhodamine lactones.

Specific examples include 3,3-bis(p-dimethylaminophenyl)-6-dimethylaminophthalide, 3-(4-diethylaminophenyl)-3-(1-ethyl-2-methylindol-3-yl)-phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrrano(2,3-d)pyrimidine-5,1′(3′H)isobenzofuran]-3′-one, 2-(diethylamino)-8-(diethylamino)-4-methyl-, spiro[5H-(1)benzopyrrano(2,3-d)pyrimidine-5,1′(3′H)-isobenzofuran]-3′-one, 2-(di-n-butylamino)-8-(di-n-butylamino)-4-methyl-, spiro[5H-(1)benzopyrrano(2,3-d)pyrimidine-5,1′(3′H)isobenzofuran]-3′-one, 2-di-n-butylamino)-8-(diethylamino)-4-methyl-, spiro[5H-(1)benzopyrrano(2,3-d)pyrimidine-5,1′(3′H)-isobenzofuran]-3′-one, 2-(di-n-butylamino)-8-(N-ethyl-N-i-amylamino)-4-methyl-, spiro[5H-(1)benzopyrrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Other examples include pyridine-, quinazoline-, and bisquinazoline-based compounds. These may be used as a mixture of two or more.

The color developing agent used is an electron-accepting compound that donates a proton to the leuco dye. Examples of the color developing agent include phenols, phenol metal salts, carboxylic acid metal salts, aromatic carboxylic acids, aliphatic carboxylic acids of 2 to 5 carbon atoms, benzophenones, sulfonic acids, sulfonates, phosphoric acids, phosphoric acid metal salts, acidic phosphoric acid esters, acidic phosphoric acid ester metal salts, phosphorous acids, phosphorous acid metal salts, monophenols, polyphenols, 1,2,3-triazole, and derivatives thereof. These may be substituted with substituents such as an alkyl group, an aryl group, an acyl group, an alkoxycarbonyl group, a carboxy group, esters of these, an amide group, and a halogen group. Other examples include bis-, tris-phenols, phenol-aldehyde condensate resins, and metal salts of these. These may be used as a mixture of two or more.

Specific examples include phenol, o-cresol, tert-butylcatechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid and an ester thereof (for example, 2,3-dihydroxybenzoic acid, and methyl 3,5-dihydroxybenzoate), resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethylpropionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl-]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylene tris-p-cresol.

The decoloring agent used may be a known decoloring agent, provided that it can erase color by inhibiting the chromogenic reaction between the leuco dye and the color developing agent under heat in the three-component system of the color forming compound, the color developing agent, and the decoloring agent. Examples include alcohols, esters, ketones, ethers, and acid amides. These may be used as a mixture of two or more.

The control panel 4 is described below.

As represented in FIG. 2, the control panel 4 includes a panel control unit 40, a display section 41, a touch panel 42, and a plurality of operation buttons 43. The control panel 4 represents a user interface. The functions of the control panel 4 include displaying guides, and accepting entry through the operation buttons and icons. For example, a user enters setting information through the control panel 4.

The control panel 4 is controlled by the panel control unit 40. The panel control unit 40 supplies to the system controller 5 the information entered at each section of the control panel 4, and controls the control panel 4 according to a control signal from the system controller 5. For example, the panel control unit 40 controls the display content displayed in the display section 41, including icons selectable on the touch panel 42, according to a control signal from the system controller 5.

The display section 41 displays information such as operation guides. The display section 41 has the touch panel 42 on the display screen. The touch panel 42 detects a location on the display screen of the display section 41 touched by a user. The panel control unit 40 and the system controller 5 use the icons displayed on the display section 41 and the location touched by a user and detected by the touch panel 42 to specify the content of the instruction entered by the user.

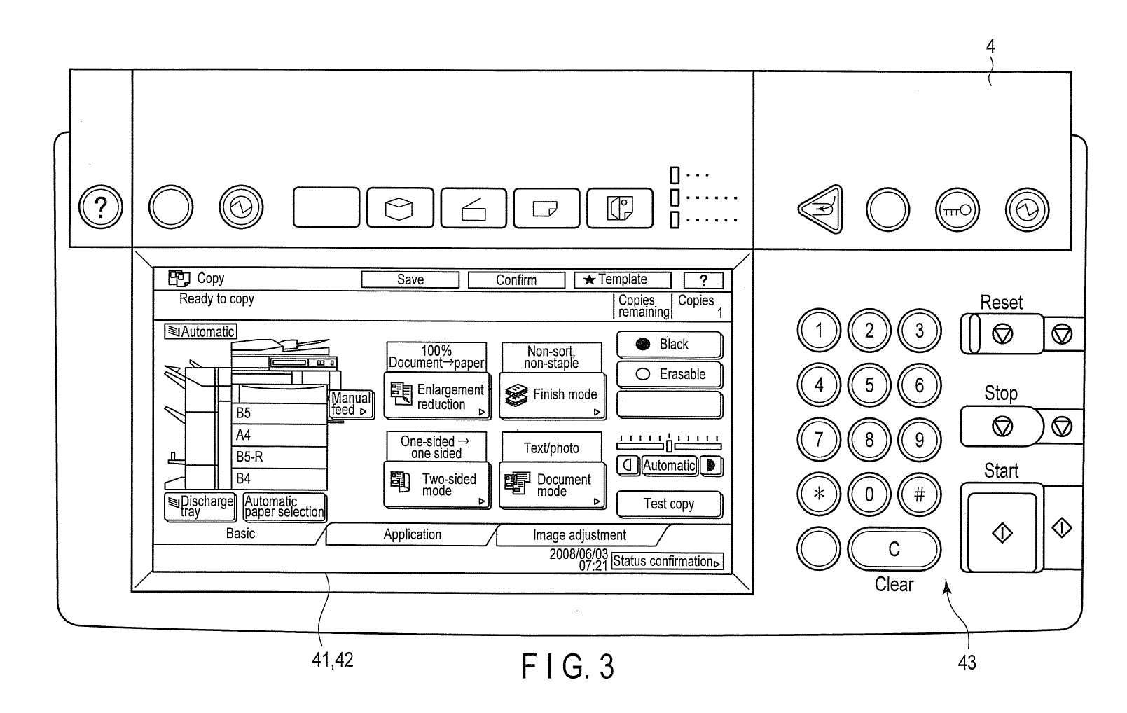

FIG. 3 is a diagram representing an example of an external configuration of the control panel 4.

In the exemplary configuration represented in FIG. 3, the control panel 4 is provided with the display section 41 having the touch panel 42, and the operation buttons 43. In the example represented in FIG. 3, the display content of the display section 41 having the touch panel 42 includes information indicative of the current status of the digital multi-functional peripheral, the current setting information, and various icons selectable by a user. The operation buttons 43 are fixed hard keys. In the example represented in FIG. 3, the operation buttons 43 provided for the control panel 4 include numeric keys, a start key, a stop key, and a reset key.

The system controller 5 is described below.

The system controller 5 is connected to various components of the digital multi-functional periphery, including the scanner 1, the printer 2, and the control panel 4. The system controller 5 controls the scanner 1, the printer 2, and the control panel 4 as a whole. In the exemplary configuration represented in FIG. 2, the system controller 5 includes a main control unit (processor) 50, a memory 51, an image memory 52, an image processing section 53, a communication unit 54, and an external interface (I/F) 55.

The main control unit 50 is provided for the overall control of the digital multi-functional peripheral. The main control unit 50 includes, for example, a processor, a RAM, and a ROM. The main control unit 50 is connected to other control units, including the control units of the scanner 1, the printer 2, and the control panel 4. The functions of the main control unit 50 include outputting operational instructions to other components such as the scanner 1, the printer 2, and the control panel 4, and acquiring various types of information from these components through bidirectional communications. For example, the main control unit 50 outputs setting information to the other components by using the currently effective setting content. Further, the main control unit 50 inputs information from the other components, including sensor detection signals, and information indicative of the operation status.

The main control unit 50 realizes various process functionalities with the processor running the programs stored in the ROM or the memory 51. For example, the main control unit 50 has a detection functionality (detector) that determines whether the image on the original document is printed with the decolorizable recording material, using the information of the original document image read by the scanner 1. Further, the main control unit 50 serves as a setting section for setting a copy mode and other settings, and stores current setting information such as a copy mode in the RAM or other storage devices.

The memory 51 stores information such as control data, control programs, and setting information. The memory 51 is realized by, for example, a rewritable nonvolatile memory. The memory 51 may be adapted to store the current setting content. The memory 51 also stores information such as default setting values for each operation mode. Further, the memory 51 stores reference values used in the detection (detection of the recording material of an original document image; described later) to determine whether the image on the original document is printed with the decolorizable recording material.

The image memory 52 is realized by, for example, a hard disk drive, and a page memory. The image memory 52 stores a plurality of image data. The image memory 52 also serves as a page memory into which image data to be processed is developed.

The image processing section 53 processes image data. The image processing section 53 corrects, and compresses or decompresses image data. The communication unit 54 represents an interface for data communications with external devices. For example, the communication unit 54 sends and receives data to and from external devices via a network under the control of a communication control section 54a.

The external interface 55 represents an interface provided for interconnections with external devices. For example, the external interface 55 is realized by an interface connected to a portable external storage device (storage medium).

The following describes the detection of the recording material of an original document image as one of the process functions of the main control unit 50.

The detection of the recording material of an original document image is a process for detecting whether the image on an original document is printed with the decolorizable recording material. Various detection methods can be used for the detection of the original document image recording material. For example, the original document image recording material may be detected by detecting a mark printed at a predetermined location (a mark indicative of printing with the decolorizable recording material), or by detecting information recorded with an ink invisible to human eye (information indicative of printing with the decolorizable recording material). In the digital multi-functional peripheral of the embodiment, a scanned image of the original document is analyzed to detect whether the original document image is printed with the decolorizable recording material.

Specifically, in the detection of the original document image recording material by the main control unit 50, the image data of a document scanned by the scanner 1 is analyzed to detect whether the original document image is printed with the decolorizable recording material. In this case, the memory 51 stores the feature amount (for example, color information) of an image printed with the decolorizable recording material. The main control unit 50 extracts the feature amount (for example, color information) from the document image (original document image) scanned by the scanner. The main control unit 50 then compares the extracted feature amount of the original document image with the reference value for the feature amount extracted from an image printed with the decolorizable recording material and stored in the memory 51 to determine whether the original document image is printed with the decolorizable recording material.

In actual practice, the digital multi-functional peripheral may use a monochromatic color other than black as the decolorizable recording material to enable a user to easily distinguish between a decolorizable image and a non-decolorizable image. In such a digital multi-functional peripheral, the image printed with the decolorizable recording material has a feature in the color (color information). The color information of the image is thus used as a feature amount to determine whether the image is printed with the decolorizable recording material. If color information is used as an image feature amount, the color information in the image data of an original document read by the scanner 1 is used to determine the original document image recording material (whether the original document image is printed with the decolorizable recording material). In this case, the memory 51 stores a reference value for the color information of an image printed with the decolorizable recording material. The main control unit 50 compares the color information of the original document image with the reference value stored in the memory to determine whether the original document image is printed with the decolorizable recording material.

If the decolorizable recording material is a decolorizable toner, the memory 51 stores the color information of an image printed with the decolorizable toner. By using the stored decolorizable toner color information (for example, color information represented by a color space (L, a, b)) in the memory 51 as a reference value, the main control unit 50 analyzes the color information of the image data read from an original document, and determines whether the original document image is printed with the decolorizable toner.

It should be noted here that, in actual practice, the density of the original document image printed with the decolorizable toner or other decolorizable recording materials is subject to some fluctuation. For this reason, the reference value used for the determination of printing with the decolorizable recording material may be set in a range of color information such as a color space (L, a, b). In this case, the memory 51 stores a range of reference values for the color information used for the determination of printing with the decolorizable recording material. In order to determine whether the original document image is printed with the decolorizable recording material, the main control unit 50 determines whether the color information of the image read from the original document falls within the range of color information reference values stored in the memory 51.

For example, if the decolorizable recording material is a blue decolorizable toner, the reference values L=60 to 86, a=+1 to +5, and b=−15 to −40 may be set for the color space (L, a, b) used to determine whether an original document image is printed with the decolorizable toner. The above-described reference values are stored in the memory 51 of the digital multi-functional peripheral in which the decolorizable process unit 22 forms an image with the blue decolorizable toner. The main control unit 50 of the digital multi-functional peripheral can then compare the color information of the original document image (scanned image of the original document) with the reference values stored in the memory 51, and determine whether the original document image is printed with the blue decolorizable toner.

Copying by the digital multi-functional peripheral is described below.

In digital multi-functional peripherals configured as above, when copying is executed, copying requires setting the copy mode to either a decolorizable copy mode in which an image is formed with the decolorizable recording material, or an ordinary copy mode (non-decolorizable copy mode) in which an image is formed with the non-decolorizable recording material. The copy mode (decolorizable copy mode or non-decolorizable copy mode) can be specified by a user. However, in digital multi-functional peripherals, either the decolorizable copy mode or the non-decolorizable copy mode is preferentially set to enable copying to be started without requiring a user to specify a setting. In the digital multi-functional peripheral of the embodiment, the decolorizable copy mode is preferentially set for the copying of original documents having images formed with the decolorizable recording material.

This is because it makes more sense to print, as a copying result, the original document image on paper using the decolorizable recording material in copying an original document having an image formed with the decolorizable recording material. Simply setting the non-decolorizable copy mode or the decolorizable copy mode as a default setting irrespective of the original document image recording material is not desirable, because the copy mode setting so presented by the digital multi-functional peripheral will not be convenient for a user. It would be reasonable that copying of an original document having an image printed with the decolorizable recording material produces a paper having the original document image printed with the decolorizable recording material.

Further, as a rule, an original document printed with the decolorizable recording material is intended for repeated use, and accordingly the confidentiality level of the document is low in many cases. Accordingly, copies of the original document printed with the decolorizable recording material are also likely to have a low confidentiality level. Considering this, it is reasonable to think that an original document image printed with the decolorizable recording material should be printed (copied) on paper also with the decolorizable recording material. This is also considered convenient for a user.

A first copying process is described below as an example of the copying performed by the digital multi-functional peripheral.

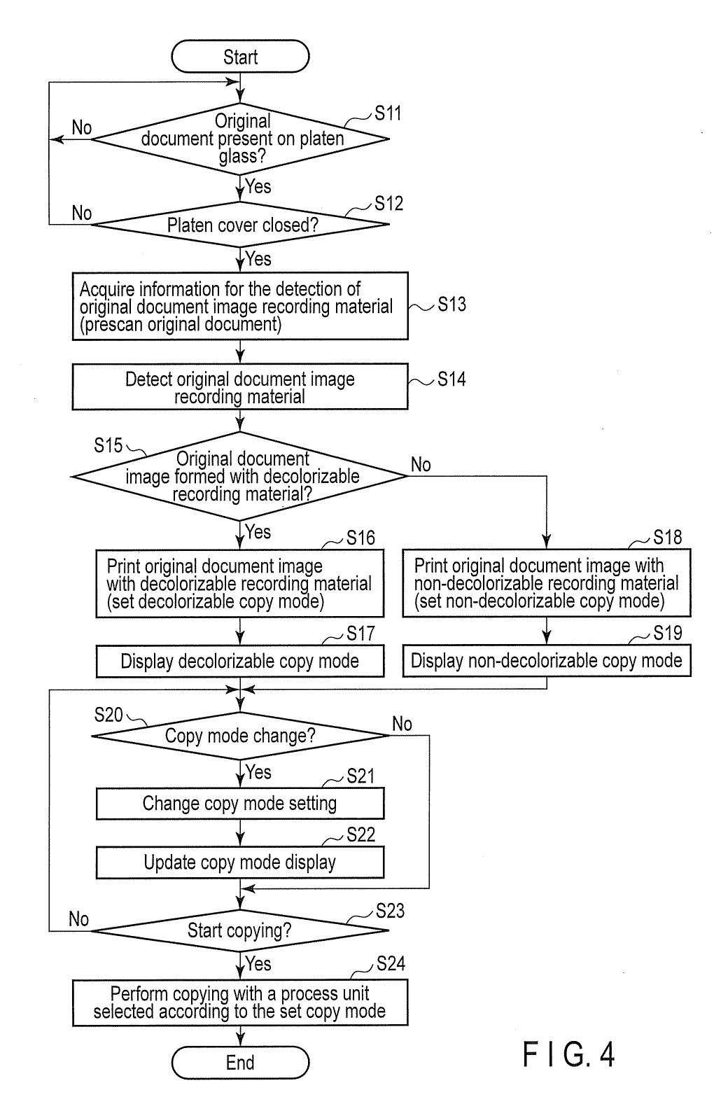

FIG. 4 is a flow chart explaining an example of a first copying process of the present digital multi-functional peripheral. The first copying process is a process that detects whether the original document image is printed with the decolorizable recording material, and that preferentially sets (presents) a copy mode according to the detection result, prior to copying. In the first copying process, it is assumed that an original document is set on the platen glass G for copying.

First, the main control unit 50 of the system controller 5 monitors to determine whether an original document is set on the platen glass G, using a detection signal from the document sensor 12 provided in the scanner 12 (Act 11). If it is determined that an original document is set on the platen glass G (Act 11, YES), the main control unit 50 determines whether the platen cover (ADF 13 in the example represented in FIG. 1) provided on the platen glass G is closed, using a detection signal from the open-close sensor 16 of the scanner 1 (Act 12).

If it is determined that the platen cover is closed (Act 12, YES), the main control unit 50 acquires information for detecting the recording material of the printed image on the original document (information for detecting whether the original document image is printed with the decolorizable recording material) (Act 13). Upon acquiring the information for detecting the image recording material (information for detecting whether the original document image is printed with the decolorizable recording material), the main control unit 50 performs the detection of the original document image recording material (determines whether the original document image is printed with the decolorizable recording material) (Act 14). For the detection of the original document image recording material, the main control unit 50 analyzes the image data on the document scanned by the scanner 1, and detects whether the original document image is printed with the decolorizable recording material.

If the platen cover is closed with the original document set in place (Act 12, YES), the main control unit 50 causes the scanner 1 to scan (prescan) the image formed on the document set on the platen glass G (Act 13), and detects the recording material of the printed image on the original document using the image data of the original document scanned by the scanner 1 (Act 14). Note that the prescan in Act 13 may be performed by acquiring the image data obtained by partially reading the original document, because the process only requires acquisition of information for detecting the image recording material.

If the detection of the original document image recording material detects that the original document image is formed with the decolorizable recording material (Act 15, YES), the main control unit 50 sets a decolorizable copy mode in which the original document image is printed on paper with the decolorizable recording material (Act 16). Upon setting the decolorizable copy mode, the main control unit 50 displays a guide on the display section 41 of the control panel 4 to indicate that the decolorizable copy mode is set (Act 17).

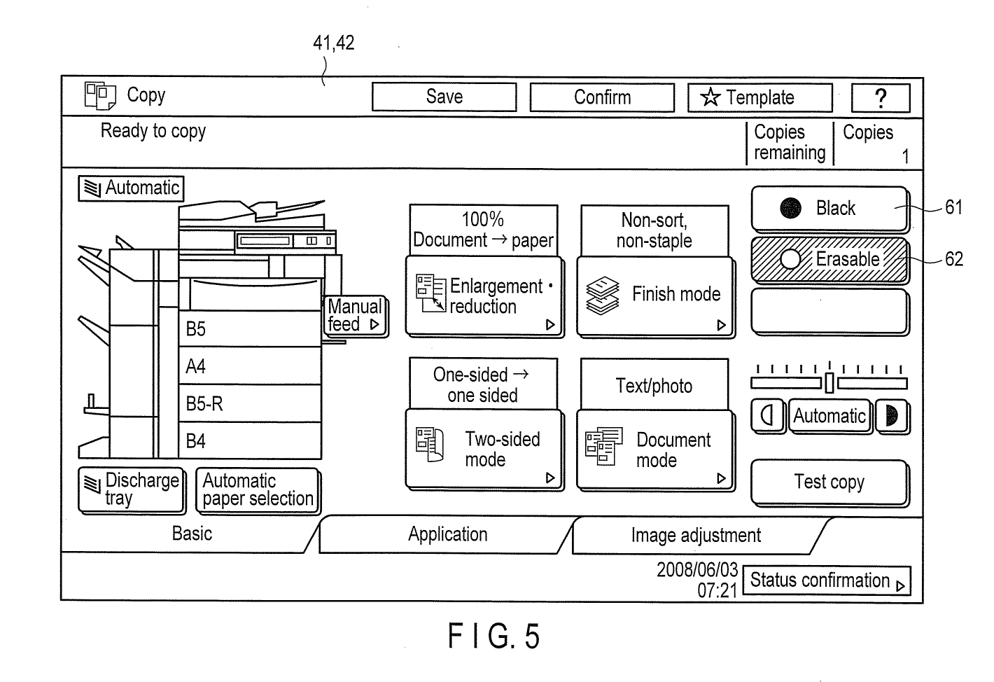

For example, FIG. 5 shows an example of a setting screen displayed in the display section 41 of the control panel 4. In the example shown in FIG. 5, the setting screen displays information that the decolorizable copy mode is currently set. Note that the setting screen shown in FIG. 5 assumes that the non-decolorizable recording material is black (the non-decolorizable process unit is adapted to form a non-decolorizable black image). For example, the setting screen assumes that the non-decolorizable recording material is colored (the non-decolorizable process unit is adapted to form a non-decolorizable color image). The icon displayed “Black” in FIG. 5 may be changed to “Color” if a color non-decolorizable recording material is used.

In the setting screen display example shown in FIG. 5, the icon displayed “Black” on the upper right of the figure represents an icon specifying a non-decolorizable copy mode (non-decolorizable black copy mode). Further, in the setting screen display example shown in FIG. 5, the icon displayed “Erasable” adjacent to the “Black” icon represents an icon specifying a decolorizable copy mode (decolorizable recording material copy mode). In the display example shown in FIG. 5, the “Erasable” icon is selected for display, indicating that the decolorizable copy mode is currently set.

If the detection of the original document image recording material detects that the original document image is not formed with the decolorizable recording material (the original document image is formed with the non-decolorizable recording material) (Act 15, NO), the main control unit 50 sets the non-decolorizable copy mode (normal copy mode) in which the original document image is printed on paper with the non-decolorizable recording material (Act 18). Upon setting the non-decolorizable copy mode, the main control unit 50 displays a guide on the display section 41 of the control panel 4 to indicate that the non-decolorizable copy mode is set (Act 19).

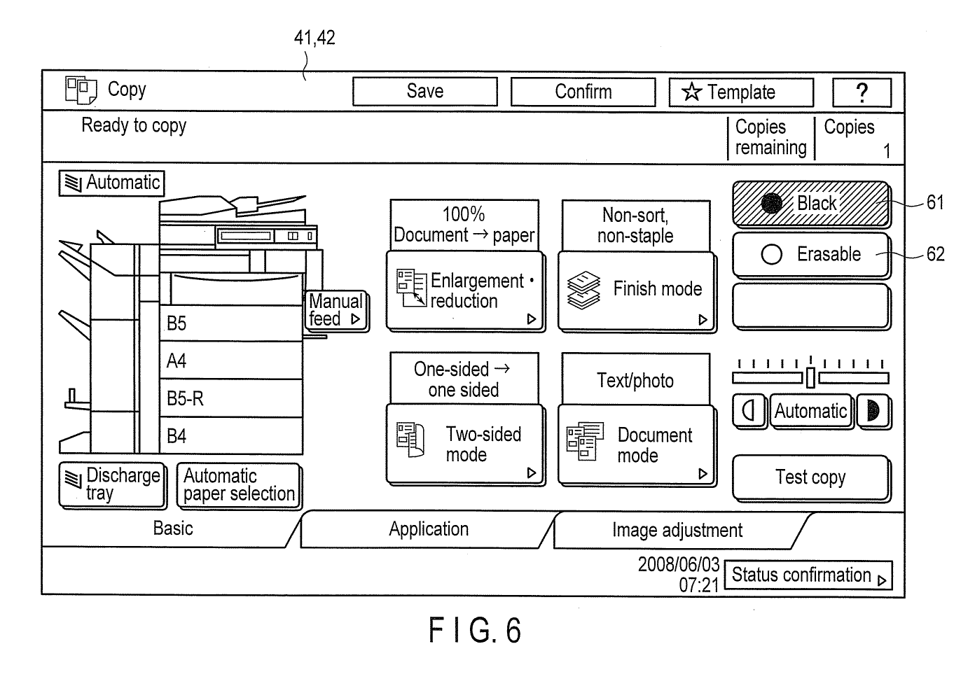

FIG. 6 shows an example of a setting screen displayed in the display section 41 of the control panel 4. In the example shown in FIG. 6, the setting screen displays information that the non-decolorizable copy mode is currently set. Note that the setting screen shown in FIG. 6, as in FIG. 5, assumes that the non-decolorizable recording material is black. The icon displayed “Black” represents an icon specifying the non-decolorizable copy mode, and the icon displayed “Erasable” represents an icon specifying the decolorizable copy mode. In the display example shown in FIG. 6, the “Black” icon is selected for display, indicating that the non-decolorizable copy mode is currently set.

In the processes performed in Acts 13 to 19, the main control unit 50 sets the decolorizable copy mode upon detecting that the original document image is printed with the decolorizable recording material, and sets the non-decolorizable copy mode upon detecting that the original document image is not printed with the decolorizable recording material. Further, with the display section 41 displaying a setting screen that reflects the copy mode set as above, the main control unit 50 enters a standby state, waiting for operation instructions from a user.

If there is an instruction for changing the copy mode displayed in the display section 41 of the control panel 4 (Act 20, YES), the main control unit 50 changes the copy mode setting according to the instruction (Act 21), and updates the setting screen by reflecting the new copy mode in the display screen 41 (Act 22).

For example, in response to a user giving an instruction for changing the currently set decolorizable copy mode to the non-decolorizable copy mode (for example, by touching the “Black” icon in the setting screen shown in FIG. 5), the main control unit 50 changes the copy mode to the non-decolorizable copy mode, and updates the setting screen to the non-decolorizable copy mode (for example, the setting screen shown in FIG. 6).

Upon entry of a key instructing to start copying (Act 23, YES), the main control unit 50 performs copying in the currently set copy mode (Act 24).

For example, upon entry of a copy start instruction in the decolorizable copy mode, the main control unit 50 causes the scanner 1 to read the original document image, and causes the printer 2 to print the scanned document image on paper with the decolorizable recording material using the decolorizable process unit 22 (copying with the decolorizable recording material). On the other hand, upon entry of a copy start instruction in the non-decolorizable copy mode, the main control unit 50 causes the scanner 1 to read the original document image, and causes the printer 2 to print the document image scanned by the scanner 1 on paper with the non-decolorizable recording material using the non-decolorizable process unit 21 (copying with the non-decolorizable recording material).

In the first copying process described above, the digital multi-functional peripheral detects whether the image of the original document set on the document platen is printed with the decolorizable recording material. If the original document image is printed with the decolorizable recording material, the digital multi-functional peripheral sets the decolorizable copy mode in which the original document image is formed on paper with the decolorizable recording material. The non-decolorizable copy mode is set if the original document image is not printed with the decolorizable recording material.

In this way, in the first copying process, the digital multi-functional peripheral can present to a user a copy mode that is set according to whether the original document image is printed with the decolorizable recording material.

A second copying process of the digital multi-functional peripheral is described below.

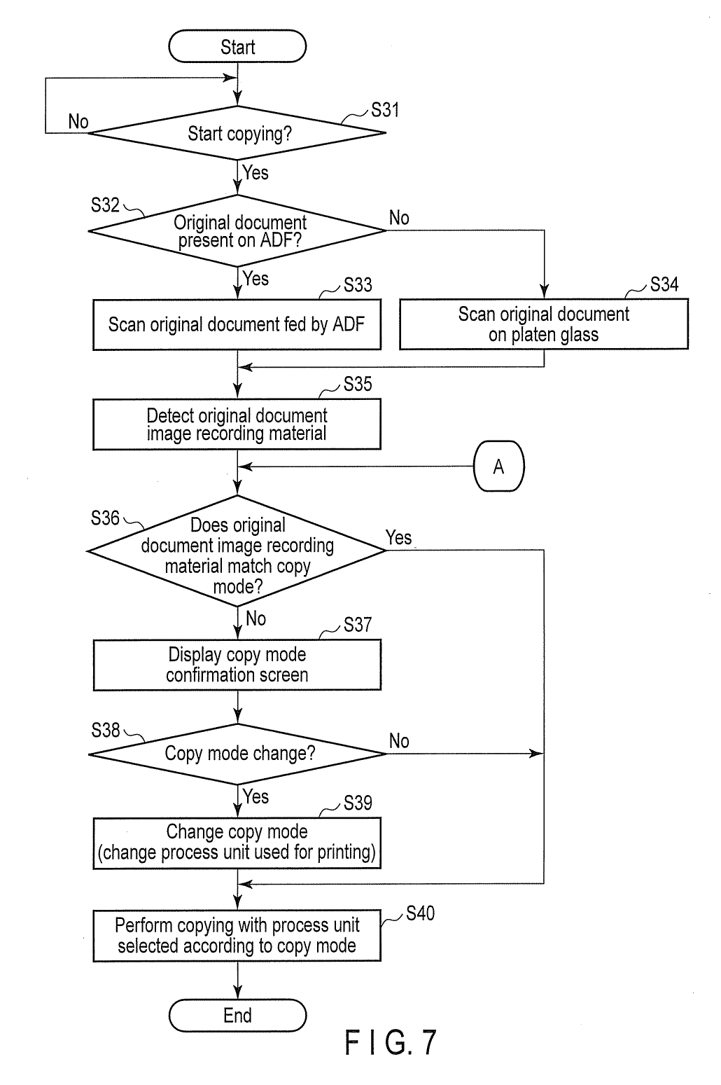

FIG. 7 is a flow chart explaining a second copying process of the present digital multi-functional peripheral. The second copying process is a process that detects whether an original document image is printed with the decolorizable recording material, and that asks for confirmation whether to change the copy mode if the detection result does not match the currently set copy mode, after the copying is started.

Upon entry of a key instructing to start copying (ACT 31, YES), the main control unit 50 checks whether an original document is present on the ADF 13 (Act 32). For example, the main control unit 50 determines whether an original document is set on the ADF 13, using a detection signal from the paper feed tray sensor 15. If it is determined that an original document is present on the ADF 13 (Act 32, YES), the main control unit 50 instructs the scanner control unit 10 to scan the original document placed on the ADF 13. In the scanner 1, the ADF 13 feeds the original document under the control of the scanner control unit 10 instructed by the main control unit 50 to scan the original document, and the image on the fed original document is scanned by the image reading section 11 (Act 33). The original document image (image data) set on the ADF 13 and scanned by the image reading section 11 is then output to the system controller 5 by the scanner control unit 10.

On the other hand, if it is determined that an original document is not present on the ADF 13 (Act 32, NO), the main control unit 50 instructs the scanner 1 to scan the original document on the platen glass G. In the scanner 1, the image reading section 11 scans the original document on the platen glass G under the control of the scanner control unit 10 instructed by the main control unit 50 to scan the original document (Act 34). The original document image (image data) set on the platen glass G and scanned by the image reading section 11 is then output to the system controller 5 by the scanner control unit 10.

Upon acquiring the original document image data from the scanner 1, the main control unit 50 performs the detection of the original document image recording material with the image data of the original document read by the scanner 1 (Act 35). For example, the main control unit 50 extracts color information from the original document image data. The main control unit 50 then determines whether the original document image recording material is the decolorizable recording material by comparing the extracted color information from the original document image data with the reference values stored in the memory 51 for the determination of the decolorizable recording material.

Following the detection of whether the original document image recording material is the decolorizable recording material, the main control unit 50 determines whether the currently set copy mode matches the original document image recording material (Act 36).

For example, upon detecting that the original document image recording material is the decolorizable recording material, the main control unit 50 determines whether the currently set copy mode is the decolorizable copy mode. Specifically, upon detecting that the original document image recording material is the decolorizable recording material, the main control unit 50 determines that the currently set copy mode (decolorizable copy mode) matches the original document image recording material (decolorizable recording material) if the current copy mode is set to the decolorizable copy mode. On the other hand, if the currently set copy mode is the non-decolorizable copy mode, the main control unit 50 determines that the currently set copy mode (non-decolorizable copy mode) does not match the original document image recording material (decolorizable recording material).

Further, upon detecting that the original document image recording material is the decolorizable recording material, the main control unit 50 determines whether the currently set copy mode is the non-decolorizable copy mode. Specifically, upon detecting that the original document image recording material is not the decolorizable recording material, the main control unit 50 determines that the currently set copy mode (decolorizable copy mode) does not match the original document image recording material (non-decolorizable recording material) if the current copy mode is set to the decolorizable copy mode. On the other hand, if the currently set copy mode is the non-decolorizable copy mode, the main control unit 50 determines that the currently set copy mode (non-decolorizable copy mode) matches the original document image recording material (non-decolorizable recording material).

Upon determining that the currently set copy mode does not match the original document image recording material (ACT 36, NO), the main control unit 50 displays a confirmation screen asking a user to confirm the copy mode. Specifically, a guide for changing the copy mode is displayed in the display section 41 (Act 37).

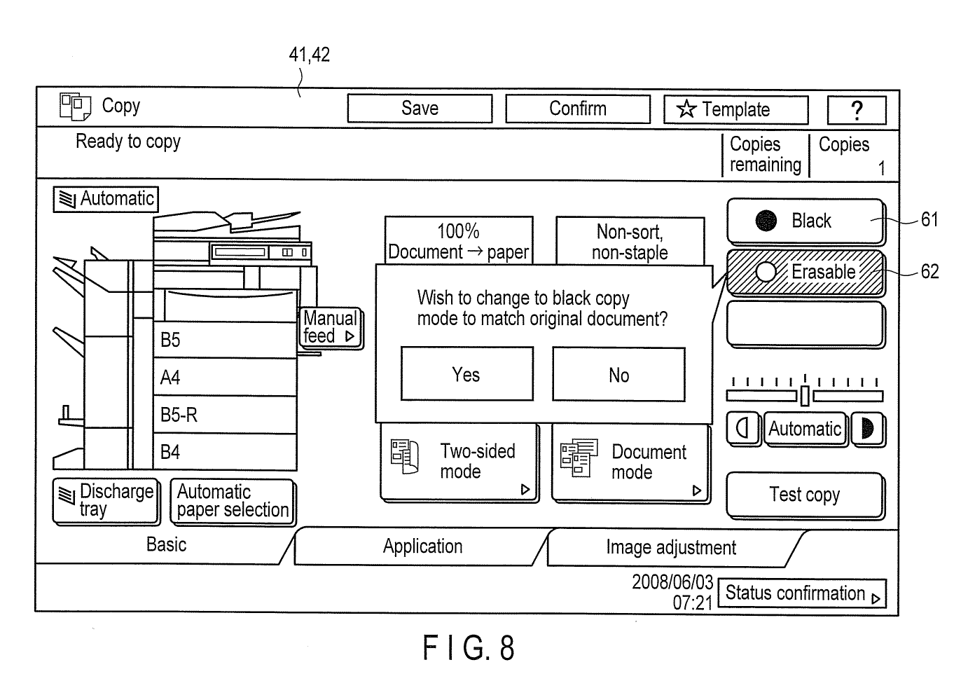

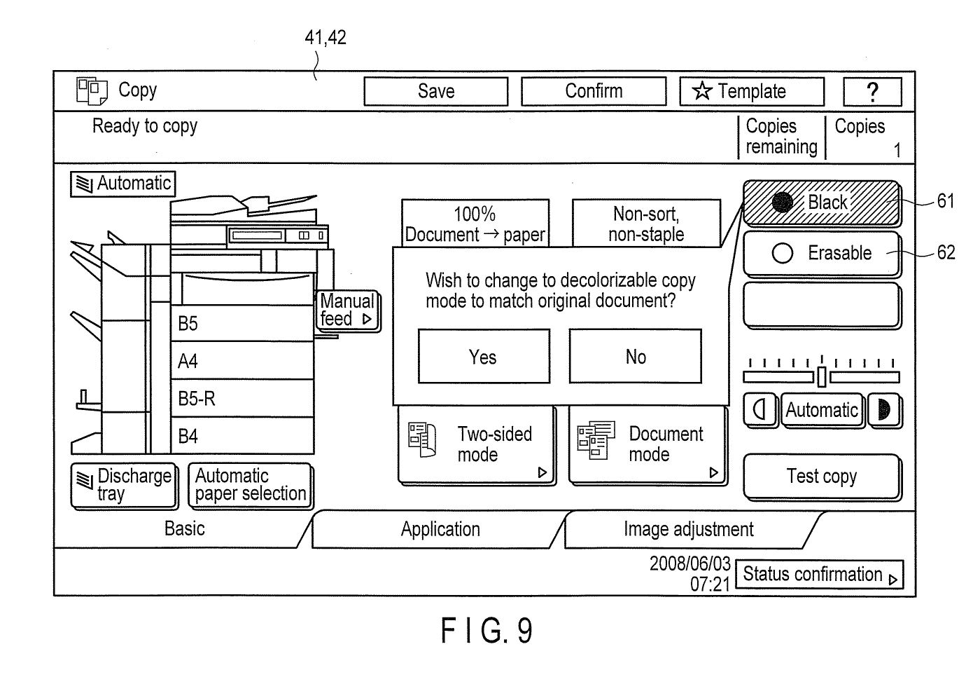

FIGS. 8 and 9 represent examples of confirmation screens displayed if there is no match between the copy mode and the recording material. For example, if the currently set copy mode is the decolorizable copy mode and the original document image recording material is the non-decolorizable recording material, the main control unit 50, as shown in FIG. 8, displays in the display section 41 a guide screen (confirmation screen) displaying “Change to black (non-decolorizable) copy mode to match the original document?” In the display example shown in FIG. 8, “YES” and “NO” icons selectable on the touch panel 42 are also displayed in the display section 41 along with the guide for changing the copy mode.

On the other hand, if the currently set copy mode is the non-decolorizable copy mode and the original document image recording material is the decolorizable recording material, the main control unit 50, as shown in FIG. 9, displays in the display section 41 a guide screen (confirmation screen) displaying “Change copy mode to decolorizable copy mode to match the original document?” In the display example shown in FIG. 9, “YES” and “NO” icons selectable on the touch panel 42 are also displayed in the display section 41 along with the guide for changing the copy mode. In the display examples shown in FIGS. 8 and 9, the main control unit 50 may be adapted to perform copying upon user input of a copy mode confirmation.

While the copy mode confirmation screen is displayed, the main control unit 50 accepts a user instruction for changing the copy mode. Upon entry of an instruction for changing the copy mode (ACT 38, YES), the main control unit 50 changes the copy mode as instructed by the user (ACT 39), and performs copying in the copy mode set (changed) by the user (Act 40).

In the absence of entry of an instruction for changing the copy mode (Act 38, NO), the main control unit 50 performs copying in the currently set copy mode (Act 40). In the second copying process described above, the digital multi-functional peripheral detects whether the original document image is printed with the decolorizable recording material in response to a copy start instruction. Upon detecting that the original document image is printed with the decolorizable recording material, the digital multi-functional peripheral displays a confirmation screen for confirming a change to the decolorizable copy mode if the currently set copy mode is the non-decolorizable copy mode. In the presence of an instruction for changing to the decolorizable copy mode, the digital multi-functional peripheral performs copying after changing the copy mode to the decolorizable copy mode. In the absence of an instruction for changing to the decolorizable copy mode, copying is performed in the non-decolorizable copy mode.

Further, upon entry of a copy start instruction, the digital multi-functional peripheral detects whether the original document image is printed with the decolorizable recording material. Upon detecting that the original document image is not printed with the decolorizable recording material, the digital multi-functional peripheral displays a confirmation screen for confirming a change to the non-decolorizable copy mode if the currently set copy mode is the decolorizable copy mode. In the presence of an instruction for changing to the non-decolorizable copy mode, the digital multi-functional peripheral performs copying after changing the copy mode to the non-decolorizable copy mode. In the absence of an instruction for changing to the non-decolorizable copy mode, copying is performed in the decolorizable copy mode.

In the second copying process described above, the digital multi-functional peripheral can ask a user for confirmation if there is no match between the original document image recording material and the copy mode, and can thus ensure that the copy mode is set as intended by a user.

A third copying process of the digital multi-functional peripheral is described below.

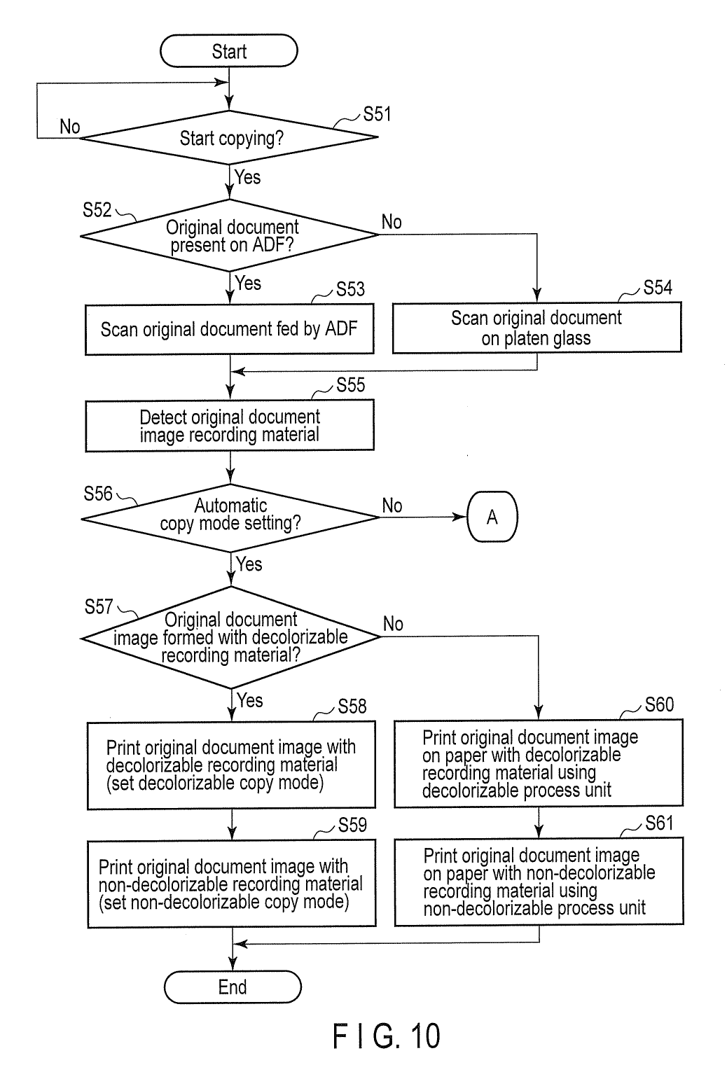

FIG. 10 is a flow chart explaining a third copying process of the digital multi-functional peripheral. The third copying process is a process that detects whether the original document image is printed with the decolorizable recording material, and that automatically sets a copy mode according to the detection result to perform copying, after the copying is started. The third copying process described below is an example of an operation in an automatic setting mode in which the decolorizable copy mode or the non-decolorizable copy mode is automatically set.

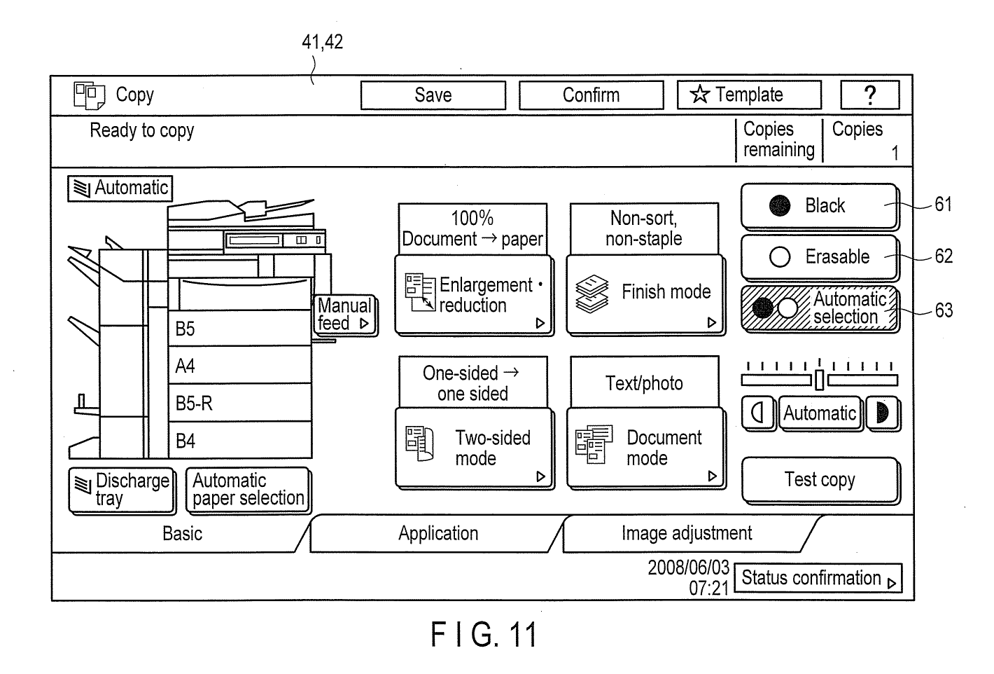

FIG. 11 represents an example of a setting screen displayed in the display section 41 of the control panel 4. In the example shown in FIG. 11, the setting screen displays information that the automatic copy mode is currently set. Note that the setting screen shown in FIG. 11 additionally displays an icon 63 reading “Automatic selection” in the setting screen shown in FIG. 5 or 6. In the display example shown in FIG. 11, the icon 63 reading “Automatic selection” is displayed along with the icon (icon specifying the non-decolorizable copy mode) 61 reading “Black”, and the icon (icon specifying the decolorizable copy mode) 62 reading “Decolorizable”.

The icon 63 reading “Automatic selection” in FIG. 11 represents an operation mode in which the digital multi-functional peripheral automatically selects either the decolorizable copy mode or the non-decolorizable copy mode. Specifically, upon entry of a copy start instruction while the icon 63 (Automatic selection) is being selected, the digital multi-functional peripheral automatically selects either the decolorizable copy mode or the non-decolorizable copy mode to perform copying.

The following describes a flow of the third copying process of the selected automatic selection mode.

First, upon entry of a key instructing to start copying (Act 51, YES), the main control unit 50 checks whether an original document is present on the ADF 13 (Act 52). If it is determined that an original document is present on the ADF 13 (Act 52, YES), the main control unit 50 causes the scanner 1 to scan the image of the original document fed by the ADF 13 (Act 53). On the other hand, if it is determined that an original document is not present on the ADF 13 (Act 52, NO), the main control unit 50 causes the scanner 1 to scan the image of an original document on the platen glass G (Act 54). The scanner 1 outputs the scanned original document image (image data) to the system controller 5.

Upon acquiring the original document image data from the scanner 1, the main control unit 50 performs the detection of the original document image recording material with the image data of the original document read by the scanner 1 (Act 55). For example, the main control unit 50 extracts color information from the original document image data. The main control unit 50 then determines whether the original document image recording material is the decolorizable recording material by comparing the extracted color information from the original document image data with the reference values stored in the memory 51 for the determination of the decolorizable recording material.

Following the detection of whether the original document image recording material is the decolorizable recording material, the main control unit 50 determines whether the currently set copy mode is the automatic setting mode (Act 56). If the current copy mode is not the automatic setting mode (Act 56, NO), the main control unit 50 performs the copying represented in Acts 36 to 40 of FIG. 8.

If the current copy mode is the automatic setting mode (Act 56, YES), the main control unit 50 performs copying in the copy mode that corresponds to the original document image recording material. Specifically, upon detecting that the original document image recording material is the decolorizable recording material (Act 57, YES), the main control unit 50 sets the decolorizable copy mode in which the original document image is printed on paper with the decolorizable recording material (Act 58). Once the decolorizable copy mode is set, the main control unit 50 causes the printer 2 to print the original document image scanned by the scanner 1 on paper with the decolorizable recording material using the decolorizable process unit 22 (Act 59).

On the other hand, upon detecting that the original document image recording material is not the decolorizable recording material (Act 57, NO), the main control unit 50 sets the non-decolorizable copy mode in which the original document image is printed on paper with the non-decolorizable recording material (Act 60). Once the non-decolorizable copy mode is set in the automatic setting mode, the main control unit 50 causes the printer 2 to print the original document image scanned by the scanner 1 on paper with the non-decolorizable recording material using the non-decolorizable process unit 21 (Act 61).

In the third copying process, the digital multi-functional peripheral in the automatic setting mode for the decolorizable or non-decolorizable copy mode detects whether the original document image is printed with the decolorizable recording material upon entry of a copy start instruction. Upon detecting that the original document image is printed with the decolorizable recording material, the digital multi-functional peripheral performs copying after setting the decolorizable copy mode. The digital multi-functional peripheral sets the non-decolorizable copy mode and performs copying upon detecting that the original document image is not printed with the decolorizable recording material.

In the third copying process, the digital multi-functional peripheral can perform copying by automatically setting a copy mode according to the result of detecting whether the original document image is printed with the decolorizable recording material. In this way, the digital multi-functional peripheral can perform copying with a recording material that matches the recording material of the original document image, without requiring a user to specify the copy mode.

As described above, the digital multi-functional peripheral detects whether the image of the original document set on the platen is printed with the decolorizable recording material. Upon detecting that the original document image is printed with the decolorizable recording material, the digital multi-functional peripheral sets the decolorizable copy mode in which the original document image is formed on paper with the decolorizable recording material. The digital multi-functional peripheral sets the non-decolorizable copy mode if the original document image is not printed with the decolorizable recording material. In this way, the digital multi-functional peripheral can present to a user a copy mode that is set according to whether the original document image is printed with the decolorizable recording material.

Further, upon entry of a copy start instruction, the digital multi-functional peripheral detects whether the original document image is printed with the decolorizable recording material. Upon detecting that the original document image is printed with the decolorizable recording material, the digital multi-functional peripheral displays a confirmation screen for confirming a change to the decolorizable copy mode if the currently set copy mode is the non-decolorizable copy mode. Upon entry of an instruction for changing to the decolorizable copy mode, the digital multi-functional peripheral performs copying after changing the copy mode to the decolorizable copy mode. In the absence of an instruction for changing to the decolorizable copy mode, the digital multi-functional peripheral performs copying in the non-decolorizable copy mode. In this way, the digital multi-functional peripheral can ask a user for the confirmation of the copy mode if there is no match between the original document image recording material and the copy mode, and can thus ensure that the copy mode is set as intended by a user.

Further, upon entry of a copy start instruction, the digital multi-functional peripheral detects whether the original document image is printed with the decolorizable recording material. Upon detecting that the original document image is not printed with the decolorizable recording material, the digital multi-functional peripheral displays a confirmation screen for confirming a change to the non-decolorizable copy mode if the currently set copy mode is the decolorizable copy mode. Upon entry of an instruction for changing to the non-decolorizable copy mode, the digital multi-functional peripheral performs copying after changing the copy mode to the non-decolorizable copy mode. In the absence of an instruction for changing to the non-decolorizable copy mode, the digital multi-functional peripheral performs copying in the decolorizable copy mode. In this way, the digital multi-functional peripheral can ask a user for the confirmation of the copy mode if there is no match between the original document image recording material and the copy mode, and can thus ensure that the copy mode is set as intended by a user.

Further, the digital multi-functional peripheral in the automatic setting mode for the decolorizable copy mode and the non-decolorizable copy mode detects whether the original document image is printed with the decolorizable recording material upon entry of a copy start instruction. Upon detecting that the original document image is printed with the decolorizable recording material, the digital multi-functional peripheral performs copying after setting the decolorizable copy mode. Upon detecting that the original document image is not printed with the decolorizable recording material, the digital multi-functional peripheral performs copying after setting the non-decolorizable copy mode. In this way, the digital multi-functional peripheral can set a copy mode according to whether the original document image is printed with the decolorizable recording material, and can automatically perform copying with a recording material that matches the recording material of the original document recording material.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a scanner which reads an image of an original document;
a first image forming section which forms an image on paper with a non-decolorizable recording material;
a second image forming section which forms an image on paper with a decolorizable recording material;
a detector which detects whether the image of the original document is formed with the decolorizable recording material; and
a setting section which sets a copy mode in which the image of the original document is formed on paper with the second image forming section, the copy mode being set upon the detector detecting that the image of the original document is formed with the decolorizable recording material.

2. The apparatus according to claim 1, wherein the decolorizable recording material is a decolorizable toner.

3. The apparatus according to claim 2, wherein the decolorizable toner is blue.

4. The apparatus according to claim 1, wherein the detector analyzes image data of the original document read by the scanner to detect whether the image of the original document is formed with the decolorizable recording material.

5. The apparatus according to claim 4, further comprising a memory which stores a reference value for a feature amount extracted from an image formed with the decolorizable recording material,
wherein the detector detects whether the image of the original document is formed with the decolorizable recording material by comparing the reference value stored in the memory with a feature amount extracted from the image data of the original document read by the scanner.

6. The apparatus according to claim 1, further comprising:
a display section which displays a setting screen that reflects the copy mode set by the setting section; and
a control unit which, upon entry of a copy start instruction in the copy mode displayed in the display section, prints on paper the image of the original document scanned by the scanner by using the first image forming section or the second image forming section as selected according to the displayed copy mode.

7. The apparatus according to claim 1,
wherein the detector detects whether the image of the original document is formed with the decolorizable recording material by using the image of the original document scanned by the scanner in response to a copy start instruction,
the apparatus further comprising a display section which, upon the detector detecting that the image of the original document is formed with the decolorizable recording material, displays a copy mode confirmation screen if the current copy mode is a copy mode in which the image of the original document is formed on paper using the first image forming section,
the setting section setting a copy mode as instructed by a user after the confirmation screen is displayed in the display section.

8. The apparatus according to claim 1,
wherein the detector detects whether the image of the original document is formed with the decolorizable recording material by using the image of the original document scanned by the scanner in response to a copy start instruction,
the apparatus further comprising a display section which, upon the detector detecting that the image of the original document is formed with the non-decolorizable recording material, displays a copy mode confirmation screen if the current copy mode is a copy mode in which the image of the original document is formed on paper using the second image forming section,
the setting section setting a copy mode as instructed by a user after the confirmation screen is displayed in the display section.

9. The apparatus according to claim 1,
wherein the detector detects whether the image of the original document is formed with the decolorizable recording material by using the image of the original document scanned by the scanner in response to a copy start instruction,
wherein the setting section which, upon the detector detecting that the image of the original document is not formed with the decolorizable recording material, sets a copy mode in which the image of the original document is formed on paper using the first image forming section, and which, upon the detector detecting that the image of the original document is formed with the decolorizable recording material, sets a copy mode in which the image of the original document is formed on paper using the second image forming section,
the apparatus further comprising a control unit which performs copying in the copy mode set by the setting section.

10. A method for setting a copy mode in an image forming apparatus,
the method comprising:
detecting whether an image of an original document is formed with a decolorizable recording material;
setting a copy mode in which the image of the original document is formed on paper using a first image forming section that forms an image on paper with a non-decolorizable recording material, the copy mode being set upon detecting that the image of the original document is not formed with the decolorizable recording material; and
setting a copy mode in which the image of the original document is formed on paper using a second image forming section that forms an image on paper with the decolorizable recording material, the copy mode being set upon detecting that the image of the original document is formed with the decolorizable recording material.
